(19) United States
(12) Patent Application Publication
(10) Pub. No.: US 2024/0033768 A1
(43) Pub. Date: Feb. 1, 2024

(54) CURTAIN COATER FOR APPLYING A TREATMENT SUBSTANCE ON AT LEAST ON APPLICATOR ROLL

(71) Applicant: Andritz Küsters GmbH, Krefeld (DE)

(72) Inventors: Eduard Davydenko, Grefrath-Oedt (DE); Andreas Pesch, Krefeld (DE); Gerald Steiner, Wien (AT)

(21) Appl. No.: 18/362,492

(22) Filed: Jul. 31, 2023

(30) Foreign Application Priority Data
Aug. 1, 2022 (EP) 22188078.4

(51) Int. Cl. B05C 1/08; B05C 5/00

(52) U.S. Cl. CPC B05C 1/0813; B05C 5/005; B05C 1/083

(57) ABSTRACT

A device for applying a treatment substance to a running paper web or board web (11) by means of at least one curtain applicator (2.1, 2.2) comprising a curtain coating die for applying the treatment substance to an applicator roll (6, 7) which, together with a second roll (6, 7), creates a treatment nip (15) in which the treatment substance is transported from the applicator roll (6, 7) to the respective side of the paper web or board web (11), and the curtain coating die has a slot adjustment (3.1, 3.2) for adjusting an exit slot (14.1, 14.2). To provide a device for applying treatment substances which improves the paper/board quality differently prepared treatment substances can be supplied to the at least one curtain coating die, and the curtain applicator (2.1, 2.2) combines the two operating modes of a film operation mode and a sump operation mode by providing an electrically and/or mechanically actuable adjusting device for the slot adjustment (3.1, 3.2) applied to the exit slot (14.1, 14.2) of the curtain coating die, which controls a die lip and sets the exit slot (14.1, 14.2) alternatively to 100 μm to 500 μm for a film operation mode or to 500 μm to 2.0 mm for a sump operation mode, so that the at least one curtain applicator (2.1, 2.2) is designed to be performed with two different operating modes.

This application claims priority to European Patent Application Number 22188078.4, entitled “A CURTAIN COATER FOR APPLYING TREATMENT SUBSTANCE ON AT LEAST ONE APPLICATOR ROLL”, filed on Aug. 1, 2022, the contents of which are hereby incorporated by reference.

The invention relates to a device for applying a treatment substance, in particular starch, a sizing agent or a gluing suspension, to a running paper web or board web by a liquid film technology.

Reclaimed fibers are increasingly used in the production of packaging papers and paperboard. For example, testliner (TL) and corrugating medium (CM) in the EU are mainly produced based on recycled paper fibers. Due to a high proportion of secondary fibers, the strength properties of packaging papers decrease. The use of starch can compensate for the loss of strength in paper production. Starch is usually either added directly into the pulp suspension or sprayed onto the wet web in the wire section. Furthermore, the starch can be applied to the paper web immediately after the pre-dryer group using contact or non-contact coating methods.

Sump presses are used to apply starch to packaging papers and board, as described, for example, in the Taschenbuch der Papiertechnik—2nd edition, chapter 10, subchapter 10.7.2 “Producing paper”. The majority of sump presses are equipped with two applicator rolls. According to the state of the art, the applicator rolls are arranged at an angle of 0° to 15° to each other. During operation, the applicator rolls close and form a nip together with the passing paper web. The starch or the size liquor is fed to the nip via so-called size tubes. A sump is formed between each applicator roll and the paper web. The starch or glue penetrates the paper as the web passes through the sump and through the nip. The application weight of the starch or glue is mainly determined by the liquid level in the sump, the dwell time, by the concentration of the liquor and by the contact pressure in the roll nip. The temperature and viscosity of the liquor as well as the porosity of the paper also have an influence on the penetration behavior and thus on the coating weight.

The temperature of the starch is usually between 50° C. and 80° C. The typical solids content of the starch in a sump press is between 5% and 12% with an application weight of 0.8 to 5.5 g/m² per side. Line forces between the applicator rolls vary between 40 and 100 kN/m. To achieve high penetration, the sump presses are operated in the upper line force range between 80 and 100 kN/m. The use of hard roll covers between 1 and 15 Pusey & Jones (P&J) enables these high contact pressures in the nip. Accordingly, hard roll covers are preferred for sump presses. Compared to film presses, sump presses have the advantage of high starch penetration into the paper.

However, due to the low solids content of the starch, sump presses have a high energy consumption. This results in poorer economic efficiency than with film presses, for example. The paper manufacturer is therefore always faced with the challenge of using the most economical process. On lines where testliner and corrugating medium are produced together, combined film/sump presses are therefore often used and operated accordingly depending on the paper grade.

For the technological and economic improvement of film presses, new non-contact devices and methods for applying the starch by means of a curtain sizer have been developed, as described, for example, in DE 20 2019 106 814 Ul and WO 2020/020626 A1. According to this, the application weight is metered via a volume flow control on the application nozzles themselves. The curtain sizer has the decisive advantage over film presses that the starch can be applied with a very high solids content of up to 25% and more.

Besides advantages, the curtain sizer also has technological limitations. It is limited as far as low viscosities of the starch are concerned. At viscosities below 30 mPa·s (at solids contents below 10%), a thin liquid film of starch becomes unstable when it hits the applicator roll, which interferes with uniform distribution of starch application. Application of a uniform thin film, as required in film press operation, is thus no longer possible. However, low viscosities with low starch contents are required to achieve high penetrations of starch into the paper. As has already been described, in these cases it is better to feed the starch via a sump than via a film.

Both coating methods, the sump application as well as the film application, have their own operating windows with different limitations as different coating units. Thus, it makes sense to use sump application at low viscosity (below 20-30 mPa.$) or low solids content (below 10%) and film application at higher viscosity (above 30 mPa-s) and higher solids content (above 10%). Using the example of the paper grades testliner (TL) and corrugating medium (CM), the state of the art is described below.

Testliner and corrugating medium are papers with a basis weight in the range of 70 to 200 g/m² made from a raw material consisting of 100% recycled paper fibers. The corrugating medium is used for the middle layer as flute in the production of corrugated board, while testliner (TL) is used for the top layer. With corrugating medium (CM) higher quality recycled paper fibers are used than with testliner (TL).

Due to different use of testliner and corrugating medium, different requirements are placed on the properties of these products. In the case of testliner, the surface smoothness and its hydrophobicity as well as the strength properties such as the ring crush test RCT, the strip crush test SCT and the bursting strength are important. In the case of corrugating medium, the surface smoothness and its hydrophobicity are unimportant, but the strength properties such as the bursting strength, the strip crush test SCT and, in particular, the flat crush test CMT are of great importance.

Due to the mentioned quality requirements, there are different targets for the surface treatment of both products with starch and sizing agents. While maximum penetration of starch into the paper is required for corrugating medium, surface treatment with starch and with glue is the main objective for testliner.

Whereas in the case of corrugating medium the highest possible penetration of starch is required to fulfill the quality properties, the aim is to fix the starch on the surface in the case of testliner (cf. Kießler, B.: Verbesserung der Papier-festigkeiten and der Prozesssicherheit bei der Oberflächenbehandlung von Wellpappenrohpapieren durch spezifische Stärkeaufschluss. PTS Research Report IW 050275, Heidenau, 2006). Accordingly, the starch solutions for these two uses are prepared differently in such a way that targeted control of the penetration depth into the paper is possible.

Since deep penetration of the starch is not required for testliner, the starch solutions for testliner have a higher viscosity and correspondingly a higher concentration (13-15%) than for corrugating medium starch (5-12%). For economic reasons, this makes sense, since with a higher solids content less energy is consumed to dry the paper. The goal of paper manufacturers here is to further increase the starch concentration. Limiting the concentration on film presses to about 15% was one of the main reasons for developing a curtain sizer for coating board. Paper manufacturers are therefore faced with the challenge of retrofitting their existing lines with additional coating units.

The sump press and curtain sizer are two independent units that must be arranged one behind the other in the line, like the blade coaters on a coating machine. As a rule, an installation of additional coating units requires an extension of the paper machine. Here, compromises have to be made in the machine construction and production process, often at the expense of paper quality.

It is therefore an object of the invention to provide a device for applying treatment substances, in particular starch or glue to packaging papers and paperboard, in particular corrugating medium (CM) and testliner (TL), which improves the achievable paper/board quality, and in particular with stable production.

The object is solved by the features of claim 1.

Herewith a device for applying a treatment substance is provided comprising at least one curtain applicator comprising a curtain coating die to apply a liquid sheet of a treatment substance that falls freely over a considerable height before it impinges onto an applicator roll, which combines the two operating modes of a film operation mode and a sump operation mode. The curtain applicator according to the invention can be operated alternatively as a film press or as a sump press and thus forms an add-on unit. Thus, the curtain coating can be performed with a curtain coating die working in two different modes. Together, the two modes effect applying a treatment substance or running paper web or paperboard web by a liquid film technology.

By making available a curtain applicator, in particular a curtain sizer, with a slot adjustment of the slot exit of the curtain coating die according to the invention, an applicator is provided which differs considerably from the design of known curtain coaters. The slot adjustment to 500 μm to 2.0 mm leads to high curtain weights, the curtain stabilization of which, however, no longer directly determines the coating quality due to the formation of a liquid sump above a roll nip. Capillary forces during the length of stay in the sump and the hydraulic pressure when passing through the nip allow the coating medium to penetrate the web. The liquid level in the sump, which is influenced by the slot adjustment according to the invention, is also a determining factor for the absorption of the treatment substance and thus for the paper/board quality.

A simple adaptation of existing sump presses to a device according to the invention comprising at least one applicator according to the invention is possible with little effort. In addition, the coating process can be changed from film coating to sump operation without shutting down the paper machine. The disadvantage that existing paper and paperboard machines often have little flexibility for retrofitting/upgrading with additional units, since this space was not planned, is thus eliminated.

Further advantages and embodiments of the invention can be found in the following description and the dependent claims.

The invention is explained in more detail below with reference to the embodiments shown in the accompanying figures.

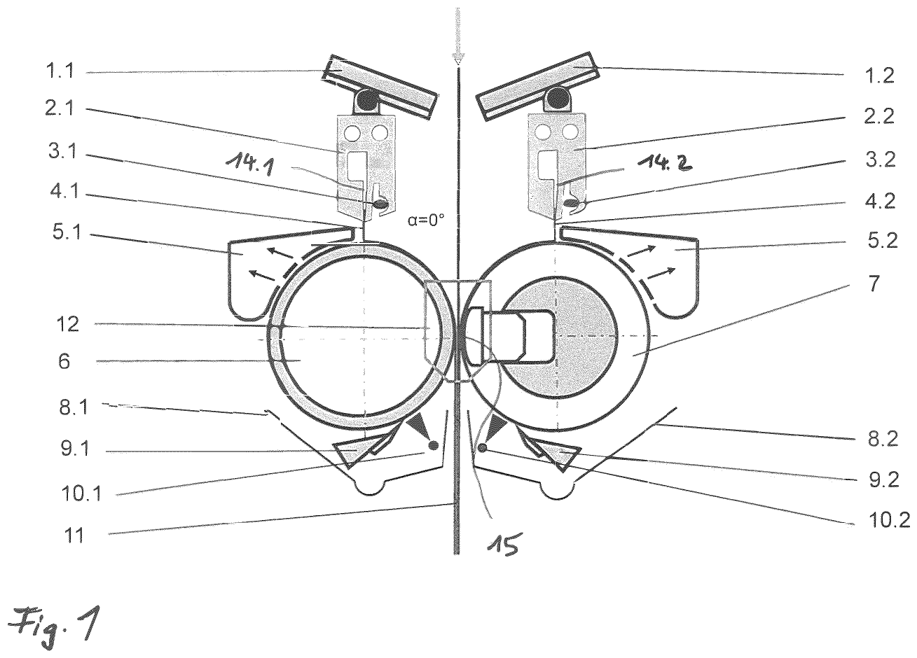

FIG. 1 schematically shows a cross-section of a device according to the invention for applying a treatment substance in a film mode,

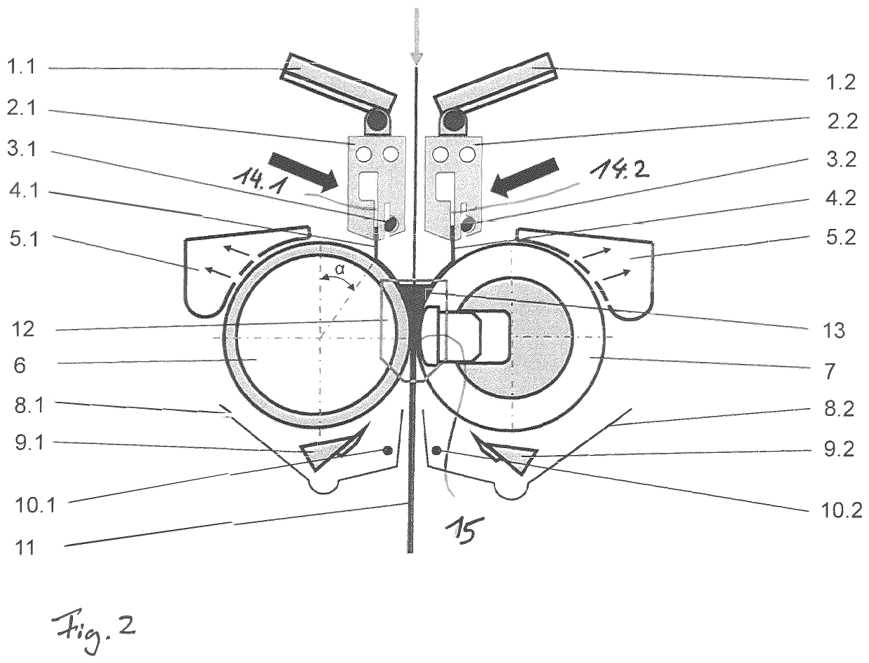

FIG. 2 schematically shows a cross-section of a device according to the invention for applying a treatment substance in a sump mode,

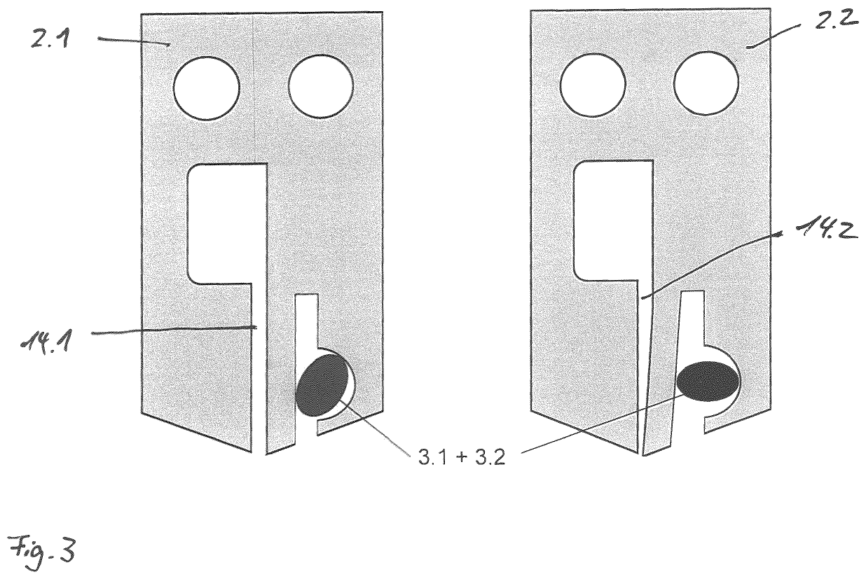

FIG. 3 schematically shows a cross-section of a curtain coater die according to the invention with a slot adjustment via an eccentric shaft,

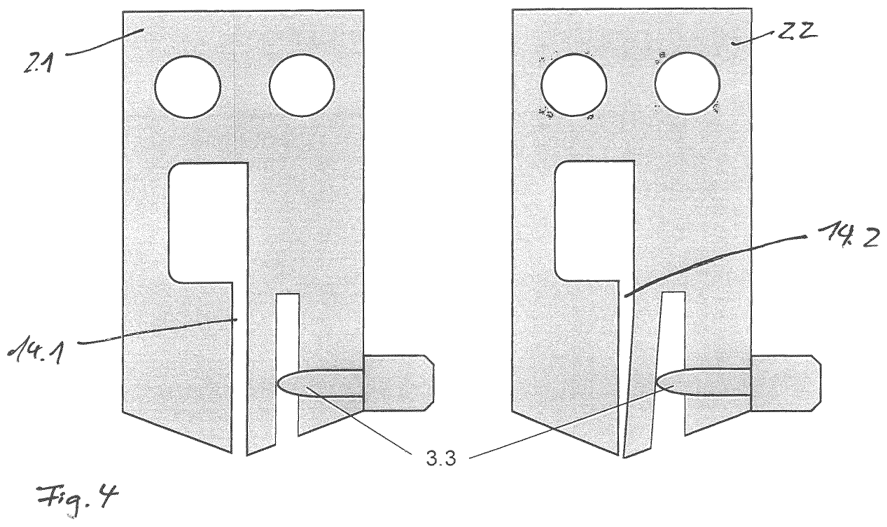

FIG. 4 schematically shows a cross-section of a curtain coater die according to the invention with a slot adjustment via a linear actuator.

The invention relates to a device for applying a treatment substance, in particular starch, a sizing agent, a glue or a gluing suspension, to a moving or running paper or paperboard web 11, in particular testliner or corrugating medium. The device comprises at least one curtain applicator 2.1, 2.2 with a curtain coating die or slit for applying the treatment substance in the form of a curtain 4.1, 4.2 to at least one applicator roll 6, 7. The curtain 4.1, 4.2 is preferably a liquid sheet that falls freely over a considerable height onto the at least one applicator roll 6, 7 that forces the coating liquid through a nip 15 on to the web 11. The one applicator roll 6 sets up the treatment nip or roll nip 15 with a second roll 7, which is also designed as an applicator roll in the case of applying treatment substance on both sides of the web 11. In the nip 15 the treatment substance, or any other kind of coating liquid used, is transferred from the applicator roll(s) 6, 7 to the respective side of the paper or paperboard web 11. The curtain coating slot of the respective curtain applicator 2.1, 2.2 also has a slot adjustment 3.1, 3.2 for adjusting the slot exit 14.1, 14.2 of the curtain coating die that defines a curtain applicator nozzle.

The at least one curtain coating die can be fed with differently prepared treatment substances. Furthermore, the slot adjustment 3.1, 3.2 of the exit slot 14.1, 14.2 to about 100 μm to 500 μm for the film operation mode and to about 500 μm to 2.0 mm for the sump operation mode allows the at least one curtain applicator 2.1, 2.2 to be operated in different modes.

For the technical implementation of the invention, the use of a curtain applicator 2.1, 2.2 combined with applicator rolls 5, 6 is preferably provided, whereby at least one applicator roll 7 can be designed as a deflection compensation roll. These rolls are known, for example, under the name S-roll, MHV-roll or NIPCO-roll.

The rolls 6, 7 for forming the roll nip 15 can be provided with hard covers, for example ceramic, chrome, but can also be provided with hard covers made of polymer. The hardness of the roll surfaces is less than 30 Pusey & Jones, preferably less than 15 P&J. The applicator rolls 6, 7 can be temperature controlled.

FIG. 1 shows an embodiment of the device according to the invention in the film operation mode. The film operation mode is an applying system, which pre-doses an exact coating liquid film, which is transferred to the web 11 in the nip 15 without any or at least nearly any significant sump. The film operation mode of the curtain applicator 2.1, 2.2 allows to apply a very high solid content of starch. Reference sign 12 indicates a possible outlet for excess treatment media.

The running direction of a web is from top to bottom and is marked with an arrow. This is, for example, the coating of a test liner (TL). The solids content of the starch is relatively high and amounts to 15%. The volume flow for the coating is accordingly relatively low. A cleaning blade 9.1, 9.2 is applied to the coating roll 6, 7 and is in the operating position. The cleaning blade 9.1, 9.2 is used to clean the applicator roll 6, 7 permanently during production. Water spray or steam nozzles 10.1, 10.2 can be provided for cleaning the applicator rolls 6, 7. Fibers and starch particles adhering to the roll surface are removed from the roll 6, 7 by the cleaning blade. A drip tray 8.1, 8.2 prevents the water from dripping onto the running paper web 11.

The curtain coating die of the curtain applicator 2.1, 2.2 can be moved hydraulically or electrically by motor. A pivoting movement of the entire unit can be provided for this purpose. In the event of an interruption in production due to a malfunction or a web break, the die and the entire unit of the curtain applicator 2.1, 2.2 can be moved to a hold position. In the hold position, the starch preferably flows into a catch pan 5.1, 5.2 and is preferably returned from there to the working depot for reuse.

In the operating mode, the curtain coating die of the curtain applicator 2.1, 2.2 is positioned in such a way that, for example, the curtain 4.1, 4.2 has an impingement zone onto the applicator roll 6, 7 aligned to the roll axis. In this case, the angle α is between zero and 45°. This position of the curtain coating die is preferably selected so that the distance from the air boundary layer suction to the curtain is minimal. This prevents disturbing influences of the boundary layer air flow along the running roll surface on the curtain. In this position, it is possible to create a stable curtain without heel formation and without unwanted backflow on the running roll 6, 7. Below a positioning of a approx. 45°, the thin curtain is disturbed by the boundary layer air flow and uniform contact with the roll surface is no longer possible.

The applicator rollers 6, 7 are preferably arranged at an angle of 0° to 15° to each other. The treatment medium can be applied first to the applicator rolls 6, 7 on both sides with a curtain 4.1, 4.2. To build up a curtain 4.1, 4.2 a die with an exit slot 14.1, 14.2 of 100-500 μm is used.

The treatment substance can be starch, a sizing agent, a glue, a glue suspension or a mixture of these media. The treatment substance is then transported to the paper or paperboard web 11 in the nip 15 between the applicator rolls 6, 7.

The respective curtain 4.1, 4.2 can have a curtain height in the range of 50 to 300 mm between the point of impact on the applicator roll 6, 7 and the die exit. Thus the liquid sheet of the curtain 4.1, 4.2 falls freely over a considerable height before it impinges onto the applicator roll 6, 7 to apply a thin liquid layer while the applicator rolls 6, 7 rotate to transfer from there the coating liquid to the running web 11 in the nip 15.

As FIG. 2 shows, in the operating mode of a sump press, the treatment substance, in particular the starch or the size liquor, can first be applied to the applicator rolls 6, 7 via the die or fed directly into a sump 13. By means of a linear guide 1.1, 1.2, for example, the curtain coating die can be positioned.

Since the starch concentration is significantly lower in a sump operation mode, i.e. the treatment substance is prepared differently from the film operation mode described above, the volume flows are correspondingly higher here. In addition, the sump operation mode requires an additionally higher volume flow to ensure a certain sump height. For example, the volume flow in the sump operation mode can be higher by a factor of 2 to 3 than in the operating mode of a curtain sizer (film operation mode). With a high volume flow rate in combination with a small exit slot of the die, the exit velocities of the starch from the die slot 14.1, 14.2 would be very high. The high exit velocities could splash and cause turbulence when the starch hits the applicator roll 6, 7 or the sump 13. This could disrupt the coating process.

In order to reduce the exit velocities from the die, the exit slot 14.1, 14.2 is adapted to the volume flow according to the invention. The exit slot 14.1, 14.2 of the die for the sump operation mode is selected larger than for curtain coating operation in a film operation mode. According to the invention, an exit slot 14.1, 14.2 of 0.5 to 2.0 mm has proven to be optimal for the sump operation mode. In order to correct or adjust the exit slot 14.1, 14.2, a slot adjustment 3.1, 3.2 is provided, preferably on a nozzle lip of the die of the curtain applicator 2.1, 2.2.

The die of the curtain applicator 2.1, 2.2 is positioned during the sump operation mode so that the angle α for the point of impact or impinge of the curtain 4.1, 4.2 on the applicator roll 6, 7 or the sump 13 is in the range between 30° and 90°, preferably between 45° and 60°.

A cleaning of the applicator roll 6, 7 is preferably not necessary in the sump operating mode, since the roll 6, 7 is cleaned by the flow of starch in the sump 13. The cleaning blade 9.1, 9.2 is swung off.

In most cases, corrugating medium (CM) and testliner (TL) are produced on the same paper machine. In this case, the changeover of grades often takes place without shutting down the paper machine. During a trouble-free change of the operating mode from film operation mode to sump operation mode, the curtain coating die of the curtain applicator 2.1, 2.2 and the entire unit can move in the direction of nip 15.

Let's assume that production on the paper machine is changed from testliner (TL) to corrugating medium (CM) while production is running. The course of procedure would then be as follows:

When switching to the operating mode of a sump press, the starch continues to be applied to the applicator roll 6, 7 via the curtain coating die. The sump operation mode requires an additional higher volume flow to set a certain sump height. According to the invention, the exit slot 4.1, 4.2 of the curtain coating die is increased for the sump operation mode in order to adapt the outlet speed to a higher volume flow. The exit slot 4.1, 4.2 of the coating die is therefore adjusted from, for example, 350 μm to approx. 1 mm, in order to switch the applicator unit to the sump operation mode. The adjustment of the exit slot 4.1, 4.2 can be realized manually, automatically (motorized or hydraulically).

When using profiling rolls, it is also possible according to the invention to operate the system in regular calender mode. For this purpose, the hard covered roll 6 would have to be equipped in such a way that higher surface temperatures can be set (thermoroll)

FIG. 3 and FIG. 4, for example, show different embodiments of the slot adjustment 3.1, 3.2 on the exit slot of the coating die. FIG. 3 shows a slot adjustment 3.1, 3.2 via an adjustment device that engages the coating die lip. The adjusting device can be, for example, an eccentric shaft, a plunger or a wedge. The adjustment device can be electrically and/or mechanically actuated. Likewise, the coating die slot could be adjusted, for example, with the aid of linear actuators 3.3. The position of the at least one curtain coating die relative to the applicator roll can be changed in such a way that a curtain height remains essentially the same in the different operating modes.

The line force in the nip 15 can be between 20 kN/m and 200 kN/m, preferably between 80 kN/m and 120 kN/m. The paper or paperboard web speed can be between 250 m/min and 2000 m/min, preferably between 600 m/min and 1800 m/min. The dry content of the paper or paperboard web 11 may be selected at more than 90%, in particular between 92% and 98%. Starch as treatment substance can be provided with a specific volume flow of between 15 l/(min*m) and 150 l/(min*m) for the sump operation mode and between 5 l/(min*m) and 50 l/(min*m) for film operation mode. Starch as an treatment medium can be provided with a solids content between 5% and 10% for the sump operation mode and between 10% and 25% for film operation mode. The viscosity of starch as treatment substance can be selected between 20 mPas and 200 mPas. The temperatures of starch as treatment substance may be selected between 50° C. and 110° C., preferably between 70° C. and 100° C.

The invention now being fully described, it will be apparent to one of ordinary skill in the art that many changes and modifications can be made thereto without departing from the spirit or scope of the appended claims. In particular, the slot die mode described can be build up in a slide die mode as well.

1. A device for applying a treatment substance to a running paper web or board web by means of at least one curtain applicator comprising a curtain coating die for applying the treatment substance to an applicator roll which, together with a second roll, creates a treatment nip in which the treatment substance is transported from the applicator roll to the respective side of the paper web or board web, and the curtain coating die has a slot adjustment for adjusting an exit slot, wherein differently prepared treatment substances can be supplied to the at least one curtain coating die, and the curtain applicator combines the two operating modes of a film operation mode and a sump operation mode by providing an electrically and/or mechanically actuable adjusting device for the slot adjustment applied to the exit slot of the curtain coating die, which controls a die lip and sets the exit slot alternatively to 100 μm to 500 μm for a film operation mode or to 500 μm to 2.0 mm for a sump operation mode, so that the at least one curtain applicator is designed to be performed with two different operating modes.

2. Device according to claim 1, wherein for the slot adjustment of the exit slot of the curtain coating die an adjusting device is provided which can be actuated electrically and/or mechanically.

3. Device according to claim 1, wherein the position of the at least one curtain coating die relative to the applicator roll is variable.

4. Device according to claim 3, wherein the position of the at least one curtain coating die relative to the applicator roll can be changed in such a way that a curtain height remains essentially the same in the different operating modes.

5. Device according to claim 1, wherein at least one of the two rolls creating the treatment nip is designed as a deflection compensation roll.

6. Device according to claim 1, wherein the diameter of the at least one applicator roll is 1000 to 1800 mm, preferably 1200 to 1600 mm.

7. Device according to claim 1, wherein the hardness of a cover of a hard applicator roll is selected in the range of 0 to 5 P&J preferably 0 to 1 P&J.

8. Device according to claim 1, wherein one of the rolls is designed as a defection compensation roll with 5 to 30 P&J, preferably 0 to 10 P&J.

9. Device according to claim 1, wherein an overflow funnel is provided in an edge region of the at least one curtain coating die in each case per edge, which overflow funnel is formed laterally of the nip.

10. Device according to claim 1, wherein the line force in the treatment nip is between 20 kN/m and 200 kN/m, preferably between 80 kN/m and 120 kN/m.

11. Device according to claim 1, wherein the speed of the web is between 250 m/min and 2000 m/min, preferably between 600 m/min and 1800 m/min.

12. Device according to claim 1, wherein the dry content of the paper or board web is selected at more than 90%, in particular between 92% and 98%.

13. Device according to claim 1, wherein the starch is provided as a treatment substance with a specific volumetric flow of between 15 l/(min*m) and 150 l/(min*m) during the sump operation mode and between 5 l/(min*m) and 50 l/(min*m) during the film operation mode.

14. Device according to claim 1, wherein the starch is provided as treatment substance with a solids content of between 5% and 12% during the sump operation mode and between 10% and 25% during the film operation mode.

15. Device according to claim 1, wherein the viscosity of starch as the treatment substance is selected between 20 mPas and 200 mPas.

16. Device according to claim 1, wherein the temperatures of starch as application medium are selected between 50° C. and 110° C., preferably between 70° C. and 100° C.

17. Device according to claim 1, wherein in the film operation mode the angle α for the zone of impingement of the curtain on the at least one applicator roller is selected between 0° and 45°, preferably between 0° and 15°, and in sump operation mode between 30° and 90°, preferably between 45° and 60°, with respect to the vertical.

18. Device according to claim 17, wherein the position of the curtain coating die and its lip is determined via a control device for a change of the operating mode during a production run.
